(19) United States
(12) Patent Application Publication
(10) Pub. No.: US 2013/0026160 A1
(43) Pub. Date: Jan. 31, 2013

(54) Waterproof Electric Case

(71) Applicant: Yu-Tung Hu, New Taipei City (TW)

(72) Inventor: Yu-Tung Hu, New Taipei City (TW)

(21) Appl. No.: 13/335,324

(22) Filed: Dec. 22, 2011

(30) Foreign Application Priority Data
Jul. 28, 2011 (TW) 100126827

(51) Int. Cl. H02G 3/08; H02G 3/10

(52) U.S. Cl. 220/3.3; 220/3.8

(57) ABSTRACT

A waterproof electric case includes a shell comprising an upper sealed part and a lower opening part, a lower lid comprising an upper opening part and a lower sealed part, at least one waterproof rubber cap covered over and inserted into a through hole of the lower sealed part of the lower lid, and a main board contained in the shell. The upper opening part includes a protruded wall and a waterproof ring disposed around an outer surface of the protruded wall, the lower lid being assembled on the inner wall of the lower opening part of the shell by the protruded wall and the waterproof ring. A fastening mechanism is disposed between the lower lid and the shell.

### RELATED APPLICATIONS

This application claims priority to Taiwan Application Serial Number 100126827, filed Jul. 28, 2011, which is herein incorporated by reference.

### BACKGROUND

1. Field of Invention

The present invention relates to an electric case. More particularly, the present invention relates to a waterproof electric case.

2. Description of Related Art

Generally, an electric case is placed outdoors for containing an electric device, such as an antenna, a solar cell, and so forth.

FIG.1 is an exploded perspective view of a conventional electric case. The electric case includes a rear shell 810, a front shell 820, a glue strip 830 disposed between the rear shell 810 and the front shell 820, a main board 840 disposed inside the rear shell 810, numerous screws 850 for fastening the rear shell 810 to the front shell 820 to thereby press the glue strip 830 therebetween, and plural connector assemblies 860 employed to receive external cables, such as network lines or power wires, for connection to the main board 840.

However, some shortcomings are associated with the aforementioned conventional electric case. For example, the joint between the rear and front shells 810, 820 is exposed outwards and is oriented such that rain may enter the electric case. This is due to the fact that the rear shell 810 and the front shell 820 are assembled side to side, namely, the configuration of the rear and front shells 810, 820 is not sufficiently waterproof. Moreover, the numerous screws 850, which are necessary for tightly compressing the waterproof glue strip 830 to improve the water tightness of the electric case, make assembly and disassembly difficult. In addition, while the waterproof property between a wire 870 and the rear and/or front shells 810, 820 is also important, the waterproof structure of the connector assemblies 860 of the conventional electric case is too complicated, and the connector assemblies 860 are difficult to assemble and are expensive. Such drawbacks are a result of the fact that each connector assembly 860 comprises a connector 861 with whorls at either end and which inserts into a corresponding hole 811 formed in the rear shell 810, a waterproof rubber sleeve 862 received in the connector 861, a ring 863 sleeved over an end of the connector 861, and two nuts 864 respectively fastened on the ends of the connector 861. Another shortcoming is that the electric case can only be hung on a column 880 and the angle between the electric case and the column 880 cannot be adjusted, so that the electric case cannot be adjusted to a preferred angle when containing an electric device such as an antenna.

### SUMMARY

In order to overcome aforementioned shortcomings of the conventional electric case, the present invention provides a waterproof electric case that is highly waterproof.

The present invention also provides a waterproof electric case that is capable of being hung in multiple ways and in which the hanging angle thereof may be adjusted.

One embodiment of the present invention provides a waterproof electric case. The waterproof electric case includes a shell comprising an upper sealed part and a lower opening part, and a lower lid comprising an upper opening part and a lower sealed part. The upper opening part comprises a protruded wall, in which a waterproof ring is disposed around an outer surface of the protruded wall. The lower lid is assembled on the inner wall of the lower opening part of the shell by the protruded wall and the waterproof ring. The lower sealed part comprises at least one through hole. A fastening mechanism is disposed between the lower lid and the shell. At least one waterproof rubber cap is covered over and inserted into the through hole, and the waterproof rubber cap comprises at least one wiring hole. A main board is disposed in the shell. Because the shell and the lower lid are assembled lengthwise, and the protruded wall and the waterproof ring of the lower lid are attached to the inner wall of the shell, good water tightness between the shell and the lower lid can be realized. Moreover, because the waterproof rubber cap is attached to the through hole, good water tightness may be achieved, and the structure is simple and easy to assemble.

In accordance with an embodiment of the present invention, the waterproof rubber cap comprises a cover sheet and a plugging body connected together. The cover sheet is covered on the outer wall of the through hole of the lower lid, and the plugging body is inserted into the through hole. A tapered flange is formed on and end of the plugging body, which is blocked on the inner wall of the through hole. Accordingly, the waterproof rubber cap is disposed on the through hole of the lower lid and maintains the water tightness of the lower lid.

In accordance with an embodiment of the present invention, a seam is formed lengthwise along the waterproof rubber cap, and is extended from the wiring hole to outside the waterproof rubber cap, so that the waterproof rubber cap has flexibility and thereby is able to be inserted into the through hole of the lower lid.

In accordance with an embodiment of the present invention, the wiring hole comprises at least one tapered part for clamping the wire.

In accordance with an embodiment of the present invention, a handle is disposed on one side of the cover sheet of the waterproof rubber cap, and at least two clamping holes are formed on the surface of the cover sheet. The waterproof rubber cap may be removed using the handle or the clamping holes.

In accordance with an embodiment of the present invention, the fastening mechanism comprises at least one fastening piece protruded from the outer surface of the lower opening part of the shell, and at least one fastening slot protruded from the outer surface of the upper opening part of the lower lid at a location corresponding to the fastening pieces. The fastening piece of the fastening mechanism is inserted into the fastening slots of the lower lid, so that the assembly of the lower lid and the shell can be kept stable.

In accordance with an embodiment of the present invention, the waterproof electric case further comprises at least two opposite locking elements screwed between the shell and the lower lid, so that the assembly of the lower lid and the shell can be more stable.

In accordance with an embodiment of the present invention, the main board comprises an inner base and a main board body fastened on the inner base. Hooks are disposed on opposite sides of the inner base, and notches are formed on the inner walls of opposite sides of the shell. The hooks are hooked in the notches, so that the assembly of the main board and the shell can be achieved.

In accordance with an embodiment of the present invention, a slot is formed at one side of the inner wall of the lower opening part of the shell, and a sheet is disposed at one side of the outer wall of the inner base corresponding to the slot. The sheet is inserted into the slot. This configuration prevents the lower opening part of the shell from deforming outwards.

In accordance with an embodiment of the present invention, a board disposed on the lower opening part of the shell comprises at least one hole for a plug.

In accordance with an embodiment of the present invention, a hanging mechanism is disposed on a rear surface of the shell. The hanging mechanism comprises a plurality of ribs disposed on the rear surface of the shell in a spaced apart manner, and a hanging plate disposed on distal ends of the ribs. The hanging plate comprises at least one hanging cavity. A channel is formed among each adjacent pair of the ribs, the hanging plate and the rear surface of the shell. The waterproof electric case can be hung on a wall or a column via the hanging cavity and the channel.

In accordance with the present invention, the hanging mechanism further comprises: at least one first U-shaped fixing bar disposed extending through one of the channels, two ends of the first U-shaped fixing bar extending outwards; an L-shaped fixing plate comprising a support plate and a securing plate with one edge vertically connected to the support plate, the support plate comprising a plurality of first fixing holes arranged in a circular configuration on the support plate, the ends of the first U-shaped fixing bar being inserted into select first fixing holes, the securing plate comprising a second fixing hole and an arc-shaped slot which is spaced apart from the second fixing hole and formed about the second fixing hole; and a second U-shaped fixing bar with two ends respectively inserted into the second fixing hole and the arc-shaped slot. The hanging angle of the waterproof electric case can be adjusted by means of inserting the first U-shaped fixing bar into first fixing holes at different positions and inserting the second U-shaped fixing bar into different positions of the arc-shaped slot.

### BRIEF DESCRIPTION OF THE DRAWINGS

The invention can be more fully understood by reading the following detailed description of the embodiment, with reference made to the accompanying drawings as follows:

FIG. 1 is an exploded perspective view of a conventional electric case;

FIG. 2 is a bottom perspective view of a waterproof electric case according to a first embodiment of the present invention;

FIG. 3 is an exploded perspective view of the waterproof electric case shown in FIG.2;

FIG. 4 is a sectional view of the waterproof electric case shown in FIG. 2;

FIG. 5 is a partial sectional view, illustrating a waterproof rubber cap of the waterproof electric case shown in FIG. 4;

FIG. 6 is a bottom perspective view of the waterproof rubber cap shown in FIG. 5;

FIG. 7 is a side, partly sectional view of the waterproof electric case shown in FIG. 2;

FIG. 8 is a side sectional view of an assembly of a shell and a main board of the waterproof electric case shown in FIG. 3;

FIG. 9 is a rear, partly exploded view of the waterproof electric case shown in FIG. 2, in which the waterproof electric case is shown having a hanging mechanism;

FIG. 10 is a view similar to FIG. 9, but showing the waterproof case with the hanging mechanism thereof in an assembled state and in a state connected to a column;

FIG. 11 is a view similar to FIG. 10, but showing the waterproof electric case and the hanging mechanism thereof from a rearward position and in a state where the waterproof electric case is hung at an upright hanging angle;

FIG. 12 is a view similar to FIG. 11, but showing the waterproof electric case in a state when hung at a different hanging angle;

FIG. 13 is a view similar to FIG. 10, but showing the waterproof electric case and the hanging mechanism thereof from a side position and in a state where the waterproof electric case is at an upright hanging angle;

FIG. 14 is a view similar to FIG. 13, but showing the waterproof electric case in a state when hung at a different tilt angle;

FIG. 15 is a bottom perspective view of a waterproof electric case without a waterproof rubber cap according to a second embodiment of the present invention;

FIG. 16 is a top perspective view of the waterproof electric case shown in FIG. 15, in which the waterproof electric case is shown from a front position and in a state where the waterproof rubber cap is assembled to the waterproof electric case;

FIG. 17 is a partly exploded perspective view of the waterproof electric case shown in FIG. 16;

FIG. 18 is an exploded perspective view of the waterproof electric case shown in FIG. 16; and

FIG. 19 is a sectional view of the waterproof electric case shown in FIG. 16.

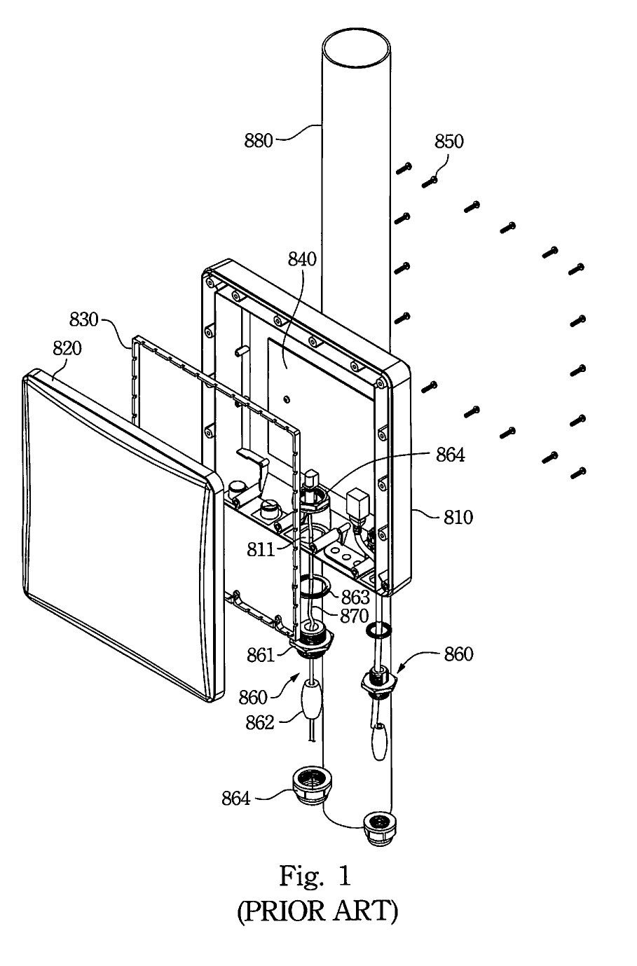

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

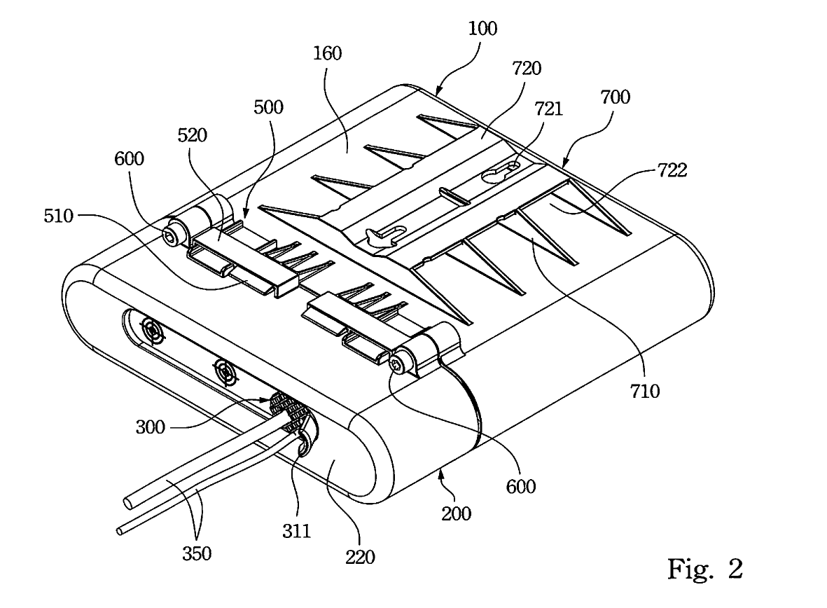

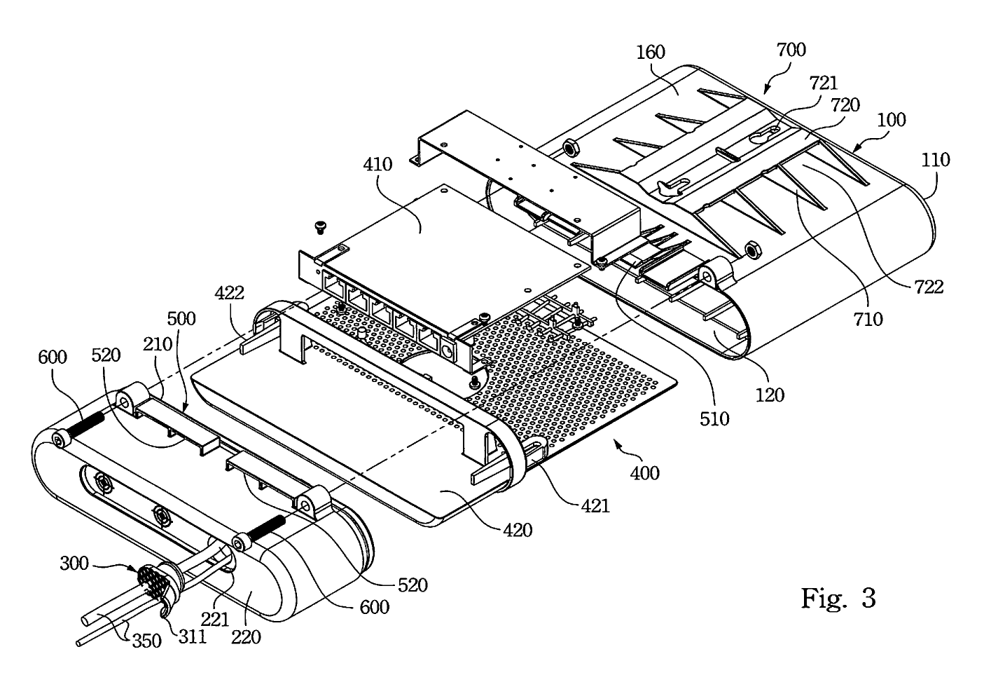

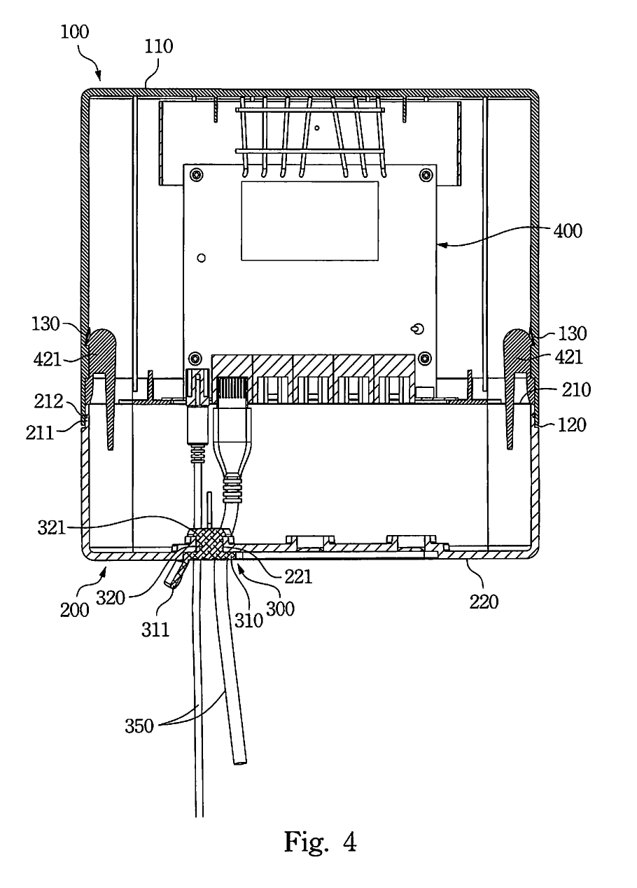

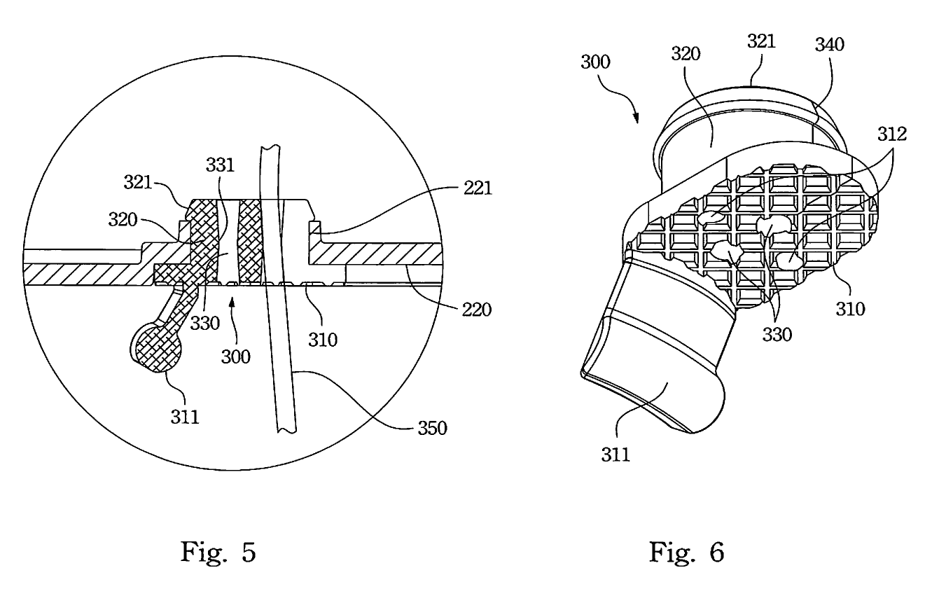

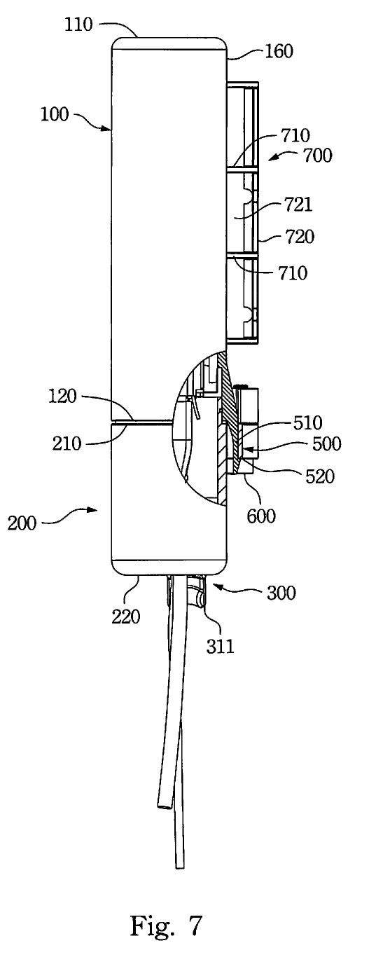

FIGS. 2-9 are views showing the structure of a waterproof electric case in accordance with a first embodiment of the present invention. The waterproof electric case comprises a shell 100, a lower lid 200, a waterproof rubber cap 300, a main board 400 and a hanging mechanism 700.

The shell 100 comprises an upper sealed part 110, a lower opening part 120, and a rear surface 160 with the hanging mechanism 700 disposed thereon.

The hanging mechanism 700 comprises a plurality of ribs 710 and a hanging plate 720. The ribs 710 are disposed on the rear surface 160 of the shell 100 in a spaced apart manner. The hanging plate 720 has two hanging cavities 721 and is disposed on distal ends of the ribs 710, that is, ends of the ribs 710 opposite ends thereof attached to the rear surface 160 of the shell 100. A channel 722 is formed by each adjacent pair of the ribs 710, the hanging plate 720 and the rear surface 160 of the shell 100. The waterproof electric case may be hung on hanging nails provided on a wall (not shown) by receiving the hanging nails in the hanging cavities 721. Alternatively, the waterproof electric case may be hung on a column (not shown) by running a chain through one of the channels 722 and securing the chain to the column.

The lower lid 200 comprises an upper opening part 210 and a lower sealed part 220. The upper opening part 210 includes a protruded wall 211 and a waterproof ring 212 disposed around an outer surface of the protruded wall 211. The lower lid 200 is assembled on the inner wall of the lower opening part 120 of the shell 100 by the protruded wall 211 and the waterproof ring 212. Good water tightness is maintained between the lower lid 200 and the shell 100 through this configuration. A through hole 221 is formed in the lower sealed part 220.

In order to ensure that the connection between the lower lid 200 and the shell 100 is stable, a fastening mechanism 500 is provided between the lower lid 200 and the shell 100. The fastening mechanism 500 comprises two fastening pieces 510 protruded from the outer surface of the lower opening part 120 of the shell 100, and two fastening slots 520 protruded from the outer surface of the upper opening part 210 of the lower lid 200 at a location corresponding to the fastening pieces 510. When the lower lid 200 is assembled on the inner wall of the lower opening part 120 by the protruded wall 211 and the waterproof ring 212, the fastening pieces 510 of the fastening mechanism 500 are inserted into the fastening slots 520 of the lower lid 100 to be releasably locked therein. As a result, the lower lid 200 is latched onto the shell 100.

The waterproof electric case further comprises two opposite locking elements 600. When the shell 100 is fastened to the lower lid 200 by the fastening mechanism 500, the locking elements 600, each of which may be a bolt, is screwed between the shell 100 and the lower lid 200, so as to make the assembly of the lower lid 200 and the shell 100 more stable.

The main board 400, which is disposed inside the shell 100, may be an electric device, such as an antenna. The main board 400 comprises an inner base 420 and a main board body 410. Hooks 421 are disposed on opposite sides of the inner base 420, and notches 130 are formed on the inner walls of opposite sides of the shell 100. The main board 400 utilizes the hooks 421 to hook onto the notches 130 of the shell 100, so that the main board 400 can be assembled with the shell 100

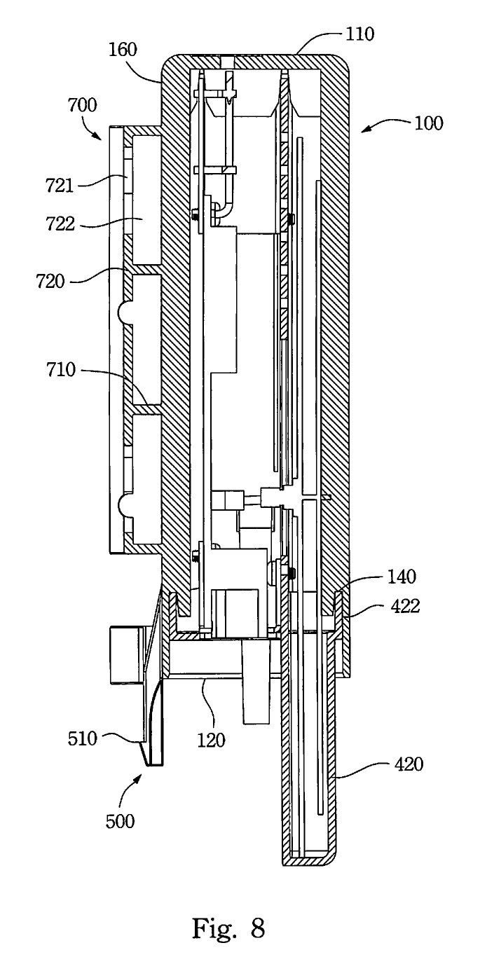

A slot 140 is formed at one side of the inner wall of the lower opening part 120 of the shell 100 (see FIG. 8), and a sheet 422 is disposed at one side of the outer wall of the inner base 420 corresponding to the slot 140. When the main board 400 and the shell 100 are assembled, the sheet 422 of the inner base 420 is inserted into the slot 140 on the inner wall of the shell 100 for preventing the lower opening part 120 of the shell 100 from deforming outwards.

The waterproof rubber cap 300 is covered over and inserted into the through hole 221 of the lower lid 200. The waterproof rubber cap 300 comprises a cover sheet 310 and a plugging body 320 connected together. The cover sheet 310 is covered on the outer wall of the through hole 221 of the lower lid 200. The plugging body 320 is inserted into the through hole 221. The end of the plugging body 320 is formed as a tapered flange 321, which is blocked on the inner wall of the through hole 221. The tapered flange 321 allows the plugging body 320 to be easily inserted into the through hole 221 but prevents the waterproof rubber cap 300 from being detached from the through hole 221, that is, from being pulled outwards from the through hole 221.

Wiring holes 330 are formed through the cover sheet 310 and the plugging body 320 of the waterproof rubber cap 300. A wire 350, such as a network line or a power wire, is electrically connected to the main board 400 by being passed through one of the wiring holes 330. A seam 340 is formed lengthwise along the waterproof rubber cap 300, and it extends from one of the wiring holes 330 to outside the waterproof rubber cap 300, so that the waterproof rubber cap 300 has flexibility and thereby is able to be inserted into the through hole 221 of the lower lid 200. Additionally, each of the wiring holes 330 comprises a tapered part 331 for clamping the wire 350 extended therethrough.

A handle 331 is formed on one side of the cover sheet 310 of the waterproof rubber cap 300. When it is desired to remove the waterproof rubber cap 300, the handle 311 can be pulled outwards, so that the tapered flange 321 of the plugging body 320 detaches from the inner wall of the through hole 221, thereby facilitating removal of the waterproof rubber cap 300 from the through hole 221. Two clamping holes 312 may be formed on the surface of the cover sheet 310 of the waterproof rubber cap 300, and clamps (not shown) may be employed by inserting the same into the clamping holes 312 and removing the waterproof rubber cap 300 from the through hole 221.

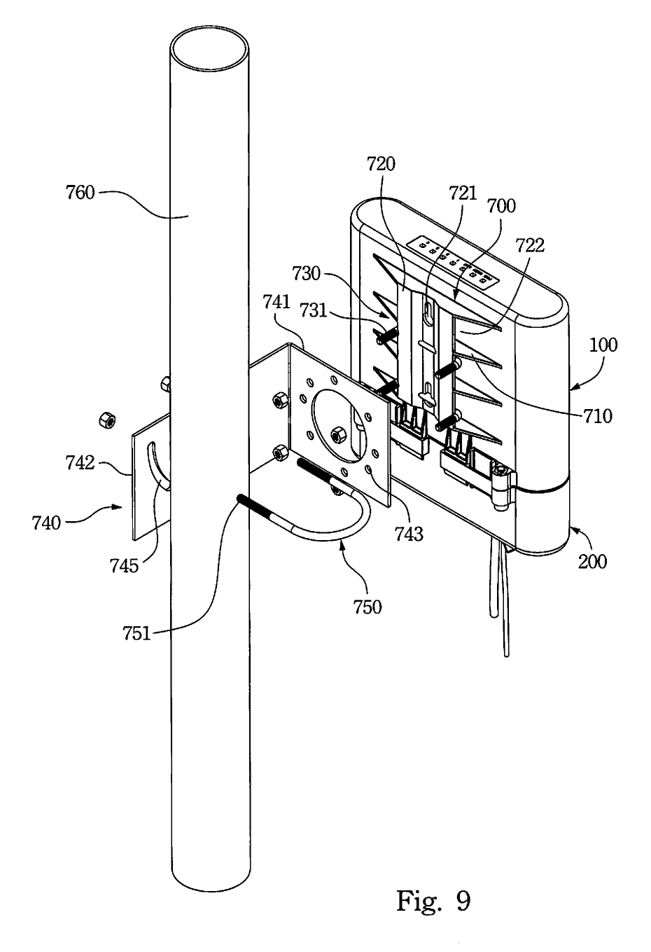

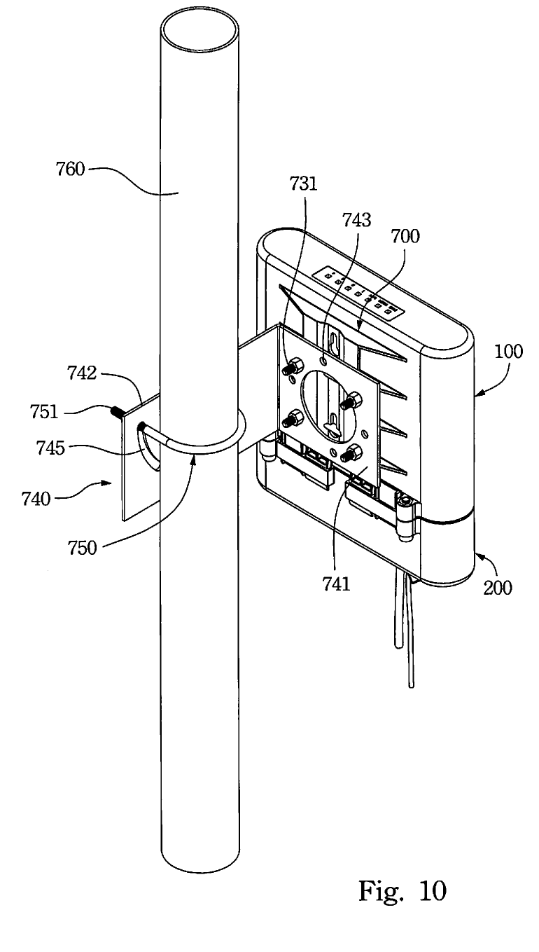

Reference is now made to both FIG. 9 and FIG. 10. The hanging mechanism 700 further comprises two first U-shaped fixing bars 730, an L-shaped fixing plate 740 and a second U-shaped fixing bar 750.

Each of the first U-shaped fixing bars 730 is disposed extending through one of the channels 722 formed on the rear surface 160 of the shell 100, and two ends 731 of the first U-shaped fixing bar 730 extend outwards. The L-shaped fixing plate 740 comprises a support plate 741 and a securing plate 742 with one edge vertically connected to the support plate 741. Plural first fixing holes 743 are arranged in a circular configuration on the support plate 741, and the ends 731 of the first U-shaped fixing bars 730 are inserted into select first fixing holes 743. The securing plate 742 comprises a second fixing hole 744 and an arc-shaped slot 745 which is spaced apart from the second fixing hole 744 and formed about the second fixing hole 744. Two ends 751 of the second U-shaped fixing bar 750 are utilized to clamp around a column 760 and are subsequently and respectively inserted into the second fixing hole 744 and the arc-shaped slot 745 of the L-shaped fixing plate 740, so that the waterproof electric case can be fastened on the column 760.

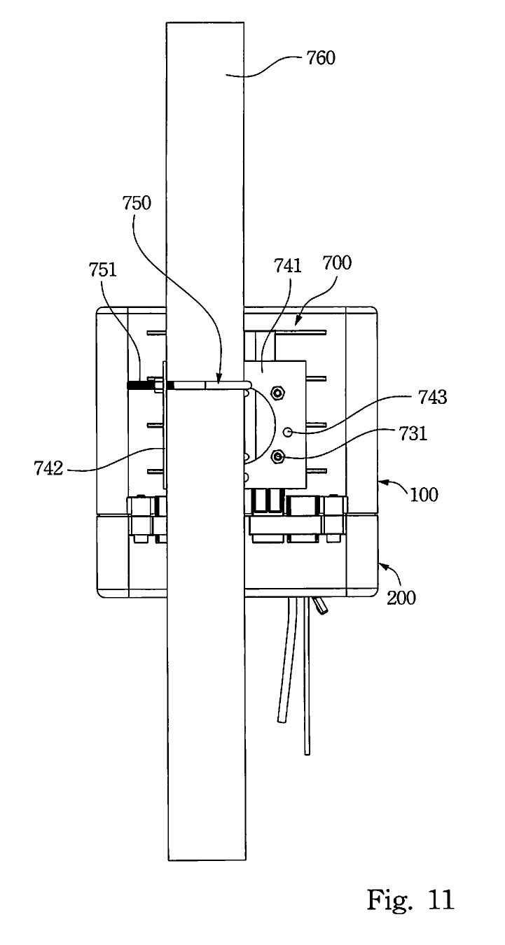

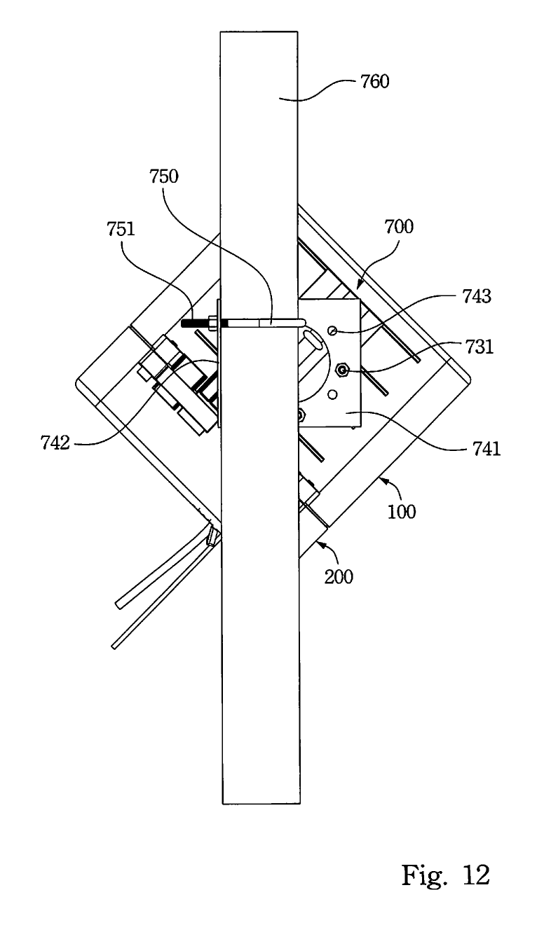

Reference is now made to both FIG. 11 and FIG. 12. The ends 731 of the first U-shaped fixing bars 730 of the hanging mechanism 700 are inserted into the first fixing holes 743 at different positions of the L-shaped fixing plate 740, so that the hanging angle of the waterproof electric base can be adjusted in a clockwise or counterclockwise direction, thereby attaining a preferred angle of the electric device. Through such a mechanism, better performance for the electric device (i.e., the main board 400) may be realized. For example, when the electric device is or comprises an antenna, adjusting the angle thereof may allow for better reception of signals by the antenna.

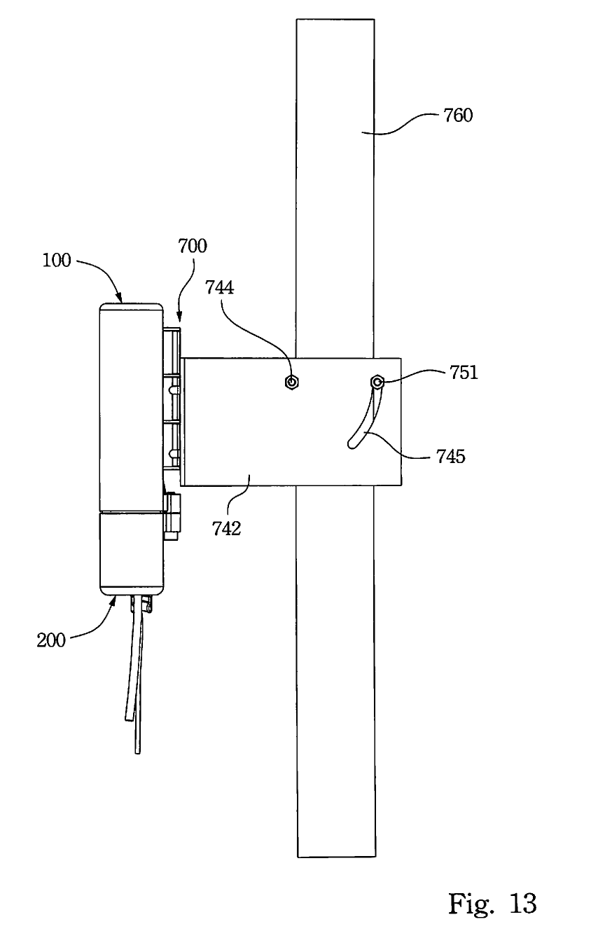

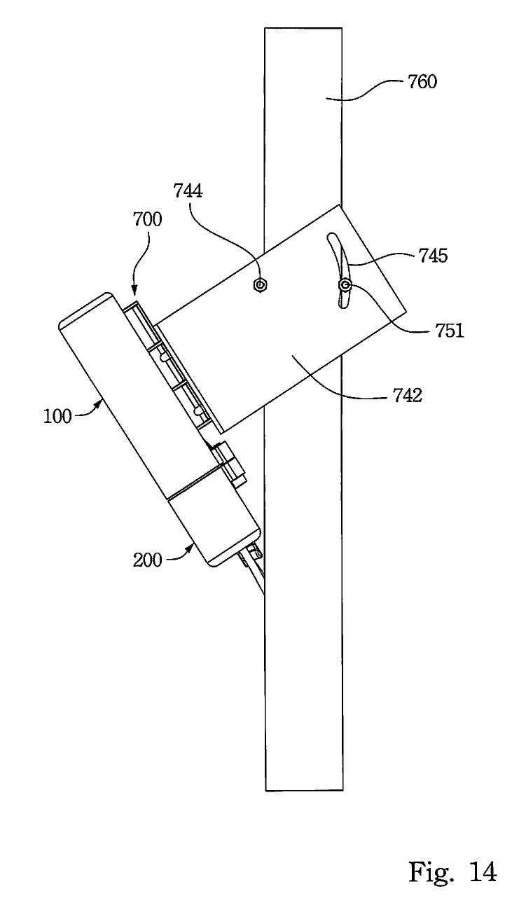

Reference is now made to both FIG. 13 and FIG. 14. The ends 751 of the second U-shaped fixing bar 750 of the hanging mechanism 700 are utilized to obtain different positions of the L-shaped fixing plate 740. That is, the waterproof electric case can be varied in tilt angle by changing the positioning of the corresponding end 751 of the U-shaped fixing bar 750 in the second fixing hole 744. As a result, a preferred tilt angle of the electric device may be obtained, and therefore, better performance for the electric device (i.e., the main board 400) may be realized, such as improved reception of signals when the electric device is or comprises an antenna.

In accordance with the waterproof electric case of the first embodiment of the present invention, the shell 100 and the lower lid 200 are assembled in a lengthwise configuration, and therefore, the seam thereof does not face the direction that rain drops fall onto the electric case. The lower lid 200 is assembled on the inner wall of the shell 100 by the protruded wall 211 and the waterproof ring 212, and such a configuration can provide favorable water tightness characteristics and can effectively prevent rain from entering the electric case through the seam between the shell 100 and the lower lid 200. The water tightness among the waterproof rubber cap 300 and the through hole 221 and the wire 350 is excellent, so that rain is prevented from entering the electric case via the through hole 221. Moreover, the structure of the waterproof rubber cap 300 is simple, thereby facilitating assembly of the same on the electric device. The shell 100 and the lower lid 200 are also easy to assemble. Hence, the water tightness between the shell 100 and the lower lid 200 is maintained by attaching the protruded wall 211 and the waterproof ring 212 of the lower lid 200 to the inner wall of the shell 100, rather than screwing numerous screws, so that the trouble and inconvenience occurring when assembling or disassembling numerous screws can be prevented. The hanging angle can be adjusted to a preferred angle by the adjustable structure of the hanging mechanism 700, so as to realize better operation and water tightness of the waterproof electric case.

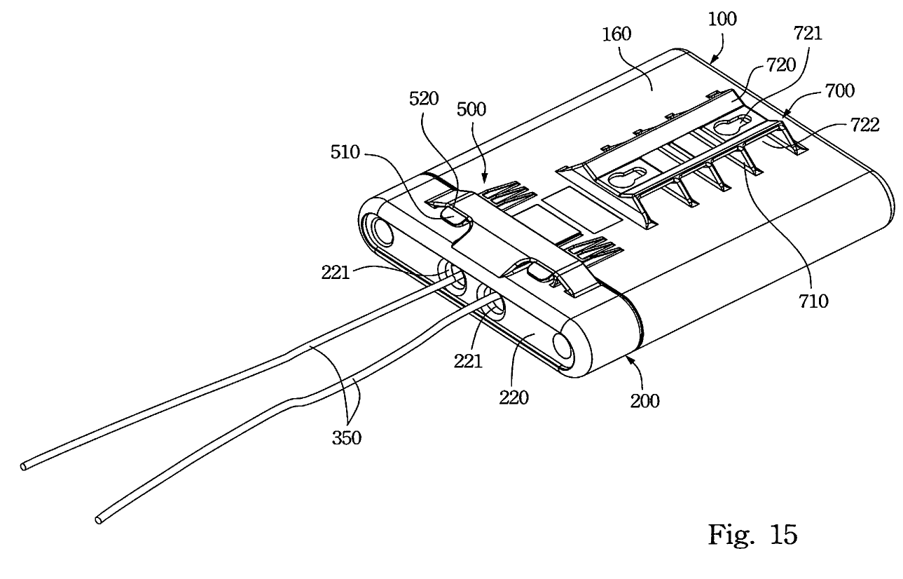

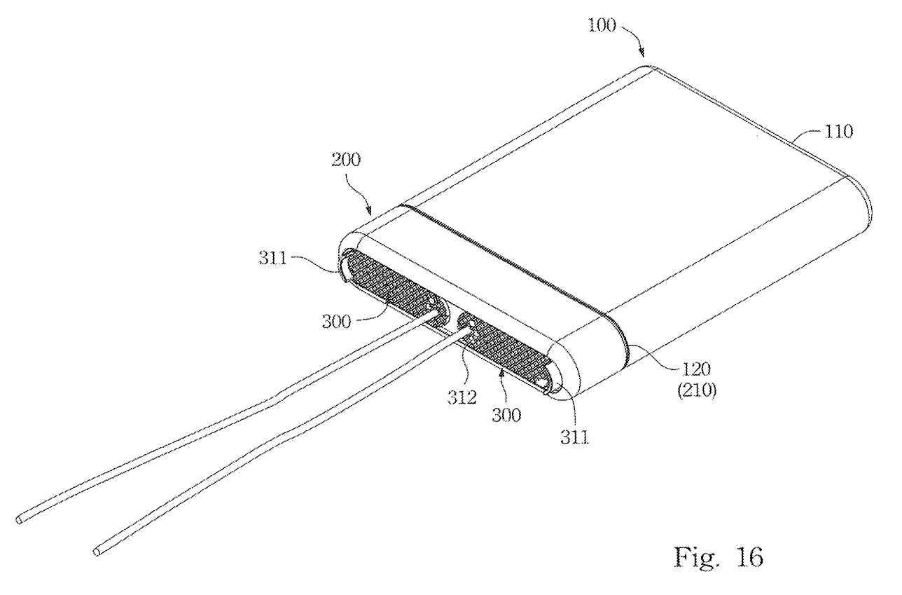

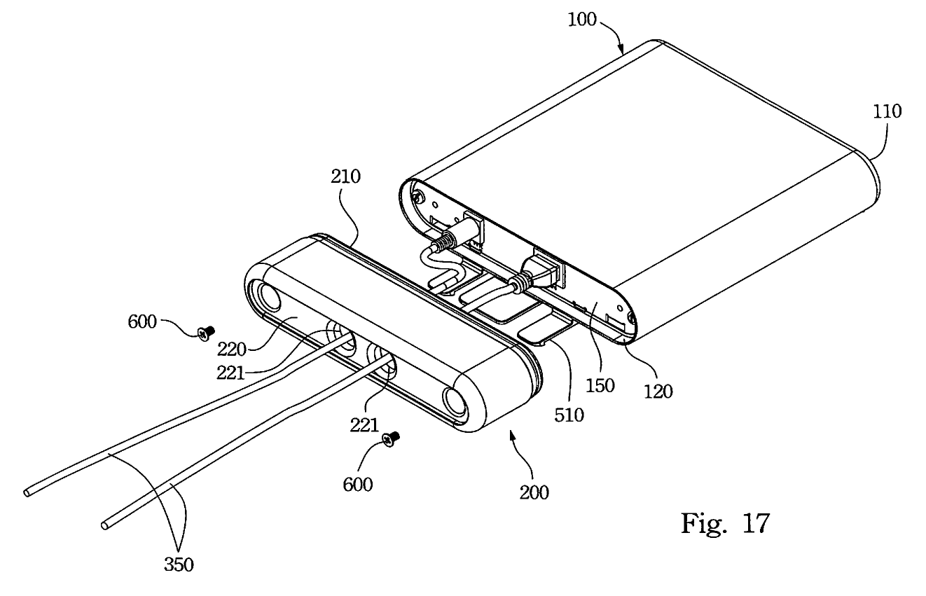

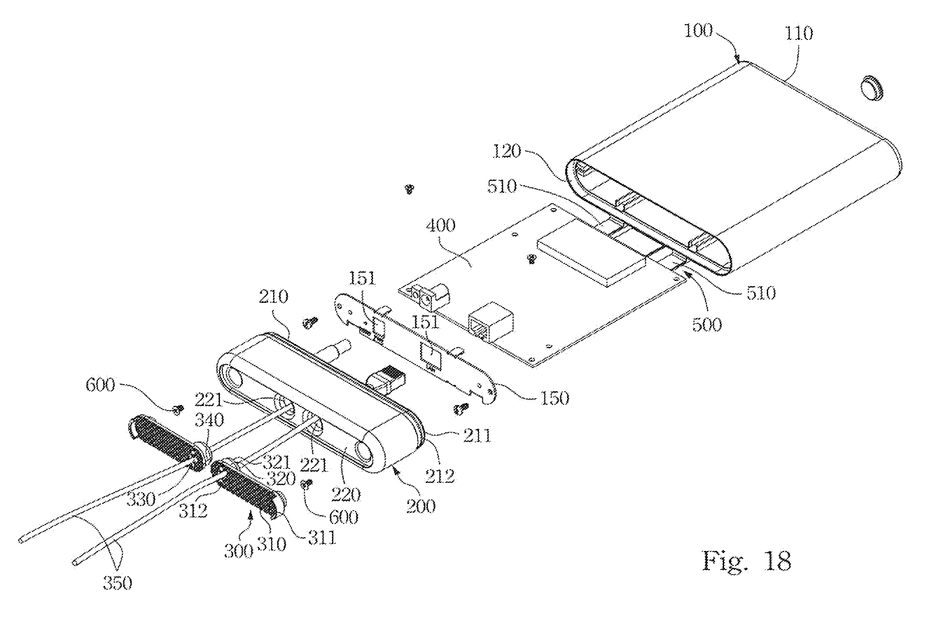

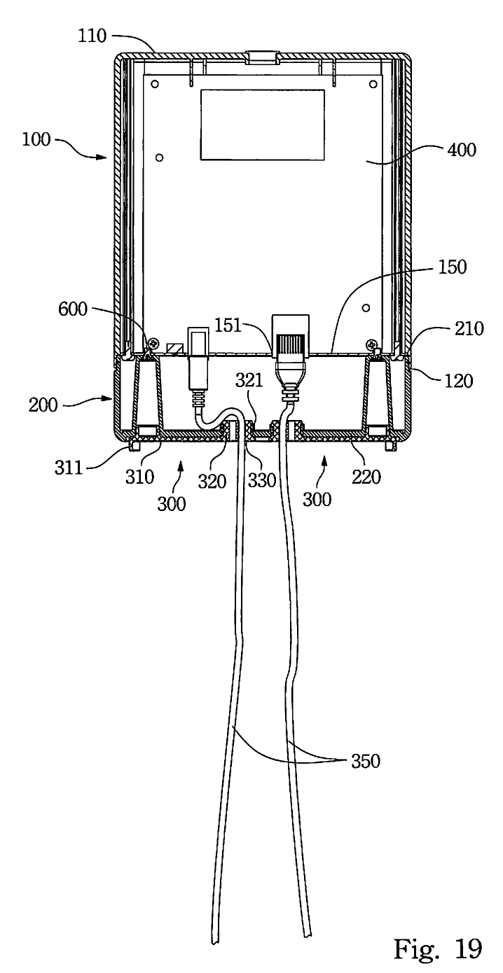

FIGS. 15-19 are views of the waterproof electric case in accordance with a second embodiment of the present invention. The structure of the second embodiment is similar to that of the first embodiment. In the second embodiment, the lower opening part 120 of the shell 100 further comprises a board 150 for sealing the lower opening part 120 at a sunken position of the lower opening part 120, so that the shell 100 is complete before the lower lid 200 is assembled. Further, the board 150 comprises two holes 151 for insertion of the plugs of corresponding wires 350. Additionally, there are two waterproof rubber caps 300 respectively covered on two through holes 221 of the lower lid 200, and the function thereof is identical to that explained with respect to the waterproof rubber cap 300 of the first embodiment.

In accordance with the second embodiment of the present invention, the waterproof electric case provides effects of simple structure, convenience of assembly, outstanding waterproof ability, and adjustable hanging angle, which are the same as the advantages provided by the first embodiment.

Although the present invention has been described in considerable detail with certain embodiments thereof, other embodiments are possible. Therefore, the spirit and scope of the appended claims should no be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A waterproof electric case, which comprises:
a shell comprising an upper sealed part and a lower opening part;
a lower lid comprising an upper opening part and a lower sealed part, the upper opening part comprising a protruded wall and a waterproof ring disposed around an outer surface of the protruded wall, the lower lid being assembled on an inner wall of the lower opening part of the shell by the protruded wall and the waterproof ring, the lower sealed part comprising at least one through hole, a fastening mechanism being disposed between the lower lid and the shell;
at least one waterproof rubber cap covered over and inserted into the through hole, the waterproof rubber cap comprising at least one wiring hole; and
a main board disposed in the shell.

2. The waterproof electrical case of claim 1, wherein the waterproof rubber cap comprises a cover sheet and a plugging body connected together, the cover sheet is covered on an outer wall of the through hole of the lower lid, the plugging body is inserted into the through hole, a tapered flange is formed at an end of the plugging body, and the tapered flange is blocked on an inner wall of the through hole.

3. The waterproof electrical case of claim 2, wherein a seam is formed lengthwise along the waterproof rubber cap and is extended from the wiring hole to outside the waterproof rubber cap.

4. The waterproof electric case of claim 3, wherein the wiring hole comprises at least one tapered part.

5. The waterproof electric case of claim 4, wherein a handle is formed on one side of the cover sheet of the waterproof rubber cap, and at least two clamping holes are formed on a surface of the cover sheet.

6. The waterproof electric case of claim 1, wherein the fastening mechanism comprises at least one fastening piece protruded from an outer surface of the lower opening part of the shell, and at least one fastening slot protruded from an outer surface of the upper opening part of the lower lid at a location corresponding to the fastening piece, and the fastening piece is inserted into the fastening slot to be releasably locked therein.

7. The waterproof electric case of claim 6, further comprising at least two opposite locking elements screwed between the shell and the lower lid.

8. The waterproof electric case of claim 1, wherein the main board comprises a main board body and an inner base, the main board body is fastened on the inner base, the inner base comprises two hooks disposed on opposite side thereof, the shell comprises two notches formed on inner walls of opposite sides of the shell, and the hook is hooked in the notch.

9. The waterproof electric case of claim 8, further comprising a slot formed on an inner wall of one side of the lower opening part of the shell, and a sheet disposed on an outer wall of one side of the inner base corresponding to the slot, the sheet being inserted into the slot.

10. The waterproof electric case of claim 1, further comprising a board disposed on the lower opening part, wherein the board comprises at least one hole for a plug.

11. The waterproof electric case of claim 1, further comprising a hanging mechanism disposed on a rear surface of the shell, the hanging mechanism comprising:
a plurality of ribs disposed on the rear surface of the shell in a spaced apart manner; and
a hanging plate disposed on distal ends of the ribs, the hanging plate comprising at least one hanging cavity, wherein a channel is formed among each adjacent pair of the ribs, the hanging plate and the rear surface of the shell.

12. The waterproof electric case of claim 11, wherein the hanging mechanism further comprises:
at least one first U-shaped fixing bar disposed extending through one of the channels, two ends of the first U-shaped fixing bar extending outwards;
an L-shaped fixing plate comprising a support plate and a securing plate with one edge vertically connected to the support plate, the support plate comprising a plurality of first fixing holes arranged in a circular configuration on the support plate, the ends of the first U-shaped fixing bar being inserted into select first fixing holes, the securing plate comprising a second fixing hole and an arc-shaped slot which is spaced apart from the second fixing hole and formed about the second fixing hole; and
a second U-shaped fixing bar with two ends respectively inserted into the second fixing hole and the arc-shaped slot.
